(19) United States
(12) Patent Application Publication
(10) Pub. No.: US 2009/0159827 A1
(43) Pub. Date: Jun. 25, 2009

(54) ROTARY GATE VALVE

(75) Inventors: Johnny W. Ellis, Reno, NV (US); David L. Gambetta, Reno, NV (US); John W. Muran, Reno, NV (US)

Correspondence Address: TYCO INTERNATIONAL, 9 ROSZEL ROAD, PRINCETON, NJ, 08540, US

(73) Assignee: TYCO VALVES & CONTROLS LP, Houston, TX (US)

(21) Appl. No.: 11/961,846

(22) Filed: Dec. 20, 2007

(51) Int. Cl. F16K 25/00

(52) U.S. Cl. 251/163

(57) ABSTRACT

A rotary knife gate valve includes a gate which rotates above a process flow axis within a pipeline. The valve includes a valve body defining a flow path having in inlet and an outlet and a knife gate channel. A shaft that has a longitudinal axis is positioned within an upper portion of the valve body. The gate has a first end connected to the shaft and positioned within the knife gate channel when the valve is in a closed position and rotationally displaced from the channel when the shaft rotates perpendicular to the shaft axis to open the valve.

### BACKGROUND OF THE INVENTION

The present invention relates generally to the field of flow control valves and the construction thereof. More specifically, the present invention relates to a rotary gate valve that provides faster operation and occupies less vertical space within a process pipeline.

Flow control valves such as, for example, knife gate valves or line blind valves, are used to control the flow of process media and can be particularly well suited for use with abrasive and corrosive slurries used in, for example, the mining, pulp or paper industries. One form of gate valve known in the art includes a housing and passageway therethrough. On opposite sides of the housing are connections for installing the valve in a pipe line, for example, the housing can be bolted to a flange end of a pipe. To control the flow of fluid through the valve, the valve includes a knife gate that is disposed within the valve body. In operation, when the knife gate is raised vertically, the valve is open and process media flows through the passageway. When the knife gate is lowered vertically, the valve is closed and process media is prevented from flowing through the passageway. Because typical knife gate valves operate vertically, actuators must be mounted on top of the gate valve. This requires significant space above the valve for the actuator and valve package in an already crowded process pipeline environment. Thus, there is a need for a gate valve that operates quicker than existing gate valves while reducing valve package vertical space requirements.

### SUMMARY OF THE INVENTION

Preferred embodiments of the inventions are directed to a rotary knife gate valve having a valve body defining a flow path having an inlet and an outlet and a knife gate channel. A shaft having a longitudinal axis is positioned within an upper portion of the valve body. The valve also includes a gate having a first end connected to the shaft and positioned within the knife gate channel. When the valve is in a closed position, the gate is positioned in the channel. To open the valve, the gate rotates away from the channel caused by rotation of the shaft about the shaft axis.

### BRIEF DESCRIPTION OF THE DRAWINGS

FIG. 1 is a perspective view of a rotary gate valve in accordance with the present invention.

FIG. 2 illustrates an exploded view of the rotary gate valve shown in FIG. 1.

### DETAILED DESCRIPTION

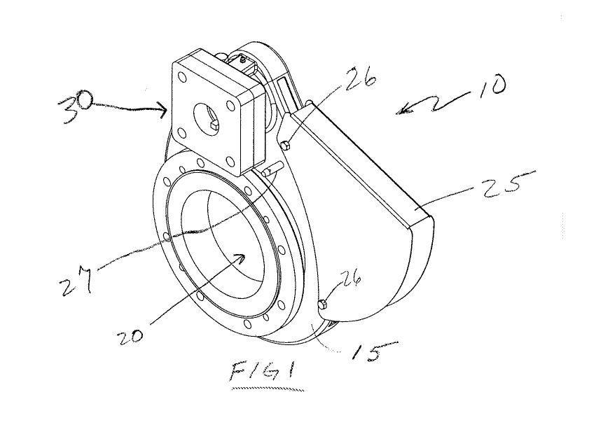

FIG. 1 is a perspective view of an embodiment of a rotary gate valve in axial alignment within a pipeline in accordance with the present invention. Valve 10 generally includes valve housing 15 defining a pathway or channel 20 having an inlet and outlet through which process media flows along a flow axis. Valve 10 is connected to a process pipeline via flange assemblies and housing 15. Valve shaft assembly 30 located at an upper portion of housing 15 allows a valve gate to swing open to allow process flow through valve 10 and swing closed to prevent process flow through valve 10. Gate guard 25 is connected to housing 15 via fasteners 26 and is used to protect the gate from external exposure. An actuator may be connected to valve shaft assembly 30 to open and close the gate. Various types of actuators may be used including pneumatic, hydraulic and electric to open and close valve 10. An actuator and valve package, including for example, a manifold can be mounted parallel to the flow axis to avoid vertical component stacking.

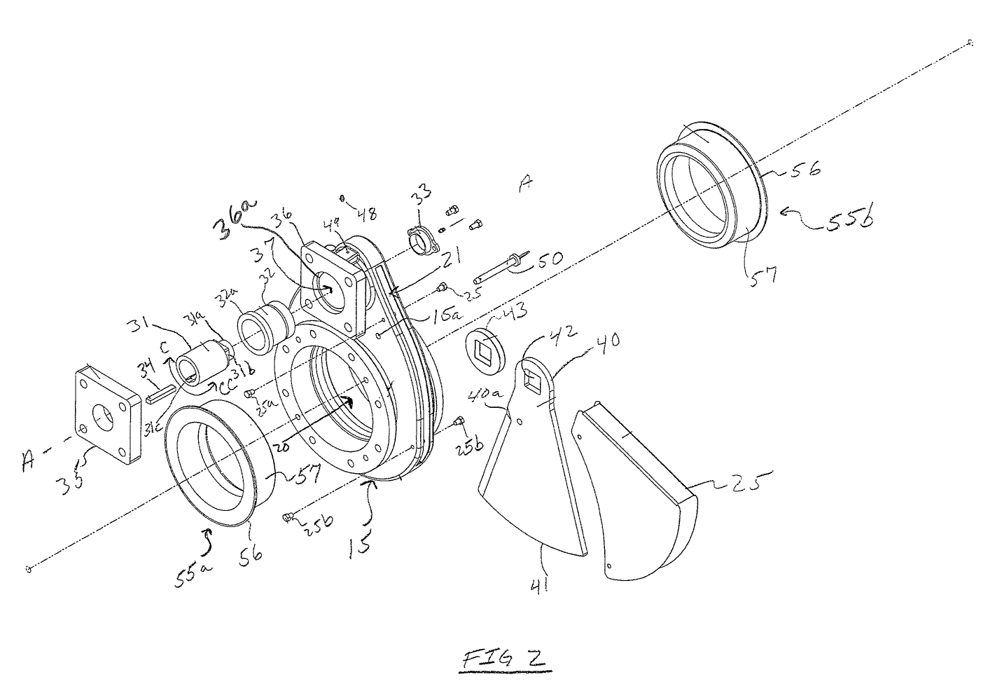

FIG. 2 is an exploded view of the rotary gate valve 10 shown in FIG. 1. Gate 40 has a substantially teardrop shape with a curved lower portion 41 and shaft aperture 42. Gate 40 is positioned within housing channel 21. When valve 10 is in a closed position, gate 40 completely covers pathway 20. Washers 43 are disposed between gate 40 and housing 15 to prevent gate 40 from rubbing and galling. Lubrication may be supplied to gate 40 via grease fitting 48 and corresponding channel 49. Gate guard 25 is attached to housing 15 via fasteners 25a and 25b. Guard 25 may be made from, for example, sheet metal or other material sufficient to protect gate 40 from environmental conditions as well as protecting users from external contact with the gate when valve 10 is in an open position.

Gate valve 10 includes shaft assembly 30 located at an upper portion of housing 15. Shaft assembly includes shaft 31, bushings 32 and 33, actuator key 34, actuator spacer 35 and housing flange 36. Shaft 31 is positioned within bushing 32 through shaft orifice 37 along axis A-A which is above and parallel with the flow axis of pathway 20. Shaft 31 has a first round end 31a connected to bushing 33 and a rectangular portion 31b which engages shaft aperture 42 of gate 40. Although portion 31b is shown have a rectangular shape, alternative configurations may be used to provide engagement with shaft aperture 42. As shaft 31 rotates in counterclockwise direction CC upon actuation, rectangular portion 31b engages shaft aperture 42 and applies the rotational force of shaft 31 to gate 40 in direction CC. This counterclockwise movement forces gate 40 outside the axis of valve housing 15 into an open position where gate 40 is completely withdrawn from the process flow. Gate guard 25 surrounds gate 30 when valve 10 is in this open position. Likewise, as shaft 31 rotates in a clockwise direction C upon actuation, rectangular portion 31b applies the rotational force of shaft 31 to gate 40 via shaft aperture 42 to rotate gate 40 in direction C. This clockwise C movement of gate 40 returns the gate inside valve housing 15 via channel 21 to close the valve. Because of its rotational configuration, gate 40 only has to travel approximately ¼ turn to go from a closed position to an open position.

Housing spacer 36 includes a ridge portion 36a which receives rim 32a of bushing 32. Bushing 32 receives shaft 31 and actuator key 34 is received by channel 31c of shaft 31. Actuator spacer 35 is connected to housing spacer 36 and receives an external actuator used to open and close valve 10. Bore 15a extends through each side of housing 15 and is aligned with lockout hole 40a of gate 40. When gate 40 is in an open position, lockout pin 50 may be inserted through bore 15a and hole 40a to prevent gate 40 from closing. This lockout function may be used in addition to actuator control.

Valve 10 also includes a pair of sleeves 55a and 55b having an inner diameter corresponding to the size of channel 20. Sleeves 55a and 55b are compressed into housing 15. Because a pair of sleeves is used, the downstream sleeve (either sleeve 55a or 55b depending on the installation configuration) can be replaced when gate 40 is in a closed position while the upstream sleeve still holds pressure. Sleeves 55a and 55b may be made from, for example, rubber, EPDM, CSM or other similar type material depending on the type of process application. Each of sleeves 55a and 55b include flange portions 56 and body portion 57. Body portions 57 fit within housing 15 and flange portions 57 fit around pathway 20. Sleeves 55a and 55b create a seal on each side of gate 40 when in a closed position and prevent leakage when gate 40 is in an open position. Retainer flanges (not shown) are disposed between each sleeve 55a and 55b and the process pipeline. These flanges retain sleeves 55a and 55b in position relative to valve housing 15.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A rotary gate valve comprising:
a valve body defining a flow path having in inlet and an outlet and a knife gate channel;
a shaft having a longitudinal axis positioned within an upper portion of said valve body; and
a gate having a first end connected to said shaft and positioned within said knife gate channel when said valve is in a closed position and rotationally displaced from said channel when said shaft rotates perpendicular to said shaft axis to open said valve.

2. The valve of claim 1 wherein said housing further comprises a pair of sleeves positioned around said flow path, a portion of each of said sleeves extending within said gate channel in sealing engagement with said gate when said valve is in a closed position.

3. The valve of claim 1 further comprising a gate guard attached to said housing, said gate guard substantially enclosing said gate when said valve is in an open position.

4. The valve of claim 1 wherein said inlet and outlet define a flow path axis which is parallel to said shaft axis.

5. The valve of claim 1 wherein rotation of said gate about said shaft axis from the open position to the closed position is defined by approximately a quarter turn of said gate.

6. The valve of claim 1 wherein said valve further comprising a lockout aperture extending from said housing through said gate, said lockout aperture adapted to receive a lockout pin, said lockout pin having a first engagement position through said gate to retain said gate in an open position.

7. The valve of claim 1 wherein said gate has a generally teardrop shape and said shaft includes a substantially rectangular shaped portion, said gate further comprising an aperture having a shape consistent with said substantially rectangular shaped portion such that rotational force from said shaft is imparted to said gate.

8. The valve of claim 4 wherein said valve housing is adapted to receive an actuator for rotating said valve shaft, said actuator positioned along said flow path axis.

9. The valve of claim 2 wherein each of said seat sleeves is molded from a rubber based material.

10. The valve of claim 1 further comprising a washer disposed between said gate and said housing about said shaft axis, said washer configured to prevent abrasion between said gate and said housing upon movement of said gate.
